(19) United States
(12) Patent Application Publication
(10) Pub. No.: US 2010/0053314 A1
(43) Pub. Date: Mar. 4, 2010

(54) INTEGRATION OF IMAGING EQUIPMENT INTO OPERATING ROOM EQUIPMENT

(75) Inventors: Christopher D. Unger, Brookfield, WI (US); Michael Sheldon, Salt Lake City, UT (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: General Electric Company, Schenectady, NY (US)

(21) Appl. No.: 12/398,398

(22) Filed: Mar. 5, 2009

Related U.S. Application Data
(60) Provisional application No. 61/093,197, filed on Aug. 29, 2008.

(51) Int. Cl. H04N 7/18

(52) U.S. Cl. 348/77; 348/E07.085

(57) ABSTRACT

The invention relates to an imaging system for use in operating rooms and other applications. According to one example, the imaging system comprises an imaging head that includes an imaging sensor that receives image information from a subject and converts the image information into an image signal, a connection such as a cable, and a control unit that receives the image signal from the imaging head through the connection. The control unit may comprise a processor programmed to control the operation of the system and to generate a plurality of image frames for transmission to a separate monitor, a video interface designed to transmit the plurality of image frames to the separate monitor, and a power interface designed to receive power from a separate power supply. The control unit may be adapted to interface with an imaging control workstation having a standard expansion slot that receives one or more control units from different imaging modalities. The control unit may also be adapted to interface with a separate imaging modality providing a separate monitor and a separate power supply. The imaging system may provide the advantages of reducing the cost of the imaging system and the required operating room floor space through shared resources, such as shared data storage, data processing, user interfaces, and network interfaces, provided by the imaging control workstation.

### CROSS-REFERENCE TO RELATED APPLICATION

This patent application claims priority to U.S. Provisional Patent Application No. 61/093,197, filed on Aug. 29, 2008, which is hereby incorporated by reference herein in its entirety.

### FIELD OF THE INVENTION

The present invention relates generally to medical imaging and more particularly to image processing systems and methods for surgical and other applications.

### BACKGROUND

Various medical imaging systems and methods have been developed to assist surgeons in performing surgical procedures. For example, surgeons may utilize endoscopes, laparoscopes, ultrasound probes and/or optical imaging systems to provide enhanced visualization of the surgical site during an operation. Prior to surgery, the imaging system is moved into the operating room and connected to any necessary inputs such as a power supply. In some cases, more than one imaging system is used, or an imaging system may be brought into the operating room in the middle of a surgery. The imaging system may include, for example, a wheeled cart, a computer with storage, an imaging head or probe, and a monitor or display.

An example of an operating room (OR) layout is depicted in FIG. 1. The patient 110 lies on the surgical table 100. There may be up to ten people in the operating room, with as many as five to six in close proximity to the surgical table, making room space close to the patient very important. Typically, the anesthesia cart 150 and the anesthesiologist have priority for space near the patient's head. Over the surgical table there may be a surgical boom 120, with multiple arms and devices on it. There is also typically one or more surgical lights or luminaries 121. There are typically monitors in various locations in the room. The number and location of the monitors may vary significantly, depending on the operating room goals and the institution. There may be a monitor 122 on the main surgical boom 120, a monitor 131 on an auxiliary ceiling mounted boom 130, and/or a monitor 140 mounted on the wall, for example.

The space limitations of the operating room can create significant challenges in management of the operating room and the various systems used by the surgeon during the operation. It may be difficult, for example, to position one or more imaging systems in the location most useful to the surgeon. Also, the various systems typically include redundant subsystems or components, such as displays, computers, power supplies, data storage devices, and so on. The redundancy of the various systems compounds the problem of limited space. The present invention addresses these aspects of known systems.

### SUMMARY

The invention relates to an imaging system for use in operating rooms and other applications. According to one example, the imaging system comprises an imaging head comprising an imaging sensor that receives image information from a subject and converts the image information into an image signal. The imaging system also comprises a control unit that receives the image signal from the imaging head. The control unit comprises a processor programmed to control the operation of the system and to generate a plurality of image frames for transmission to a separate monitor, a video interface designed to transmit the plurality of image frames to the monitor, and a power interface designed to receive power from a separate power supply. The imaging system also comprises a connector, such as a cable, that connects the imaging head and the control unit. The control unit may be adapted to interface with an imaging control workstation having a standard interface that receives the control unit. The control unit may also be adapted to interface with a separate, standalone imaging modality providing the separate monitor and the separate power supply. The imaging system may provide the advantages of reducing the cost of the imaging system and the required operating room floor space through shared resources, such as shared data storage, data processing, user interfaces, and network interfaces, provided by the imaging control workstation or the standalone imaging modality.

### BRIEF DESCRIPTION OF THE DRAWINGS

These and other features and aspects of exemplary embodiments of the invention will become better understood when reading the following detailed description with reference to the accompanying drawings, in which like characters represent like parts throughout the drawings, and wherein:

FIG. 1 is a diagram of various components commonly found in an operating room;

FIG. 2 is a diagram of an optical imaging system that includes an imaging head and a control box according to an exemplary embodiment of the invention; and

FIG. 3 is a diagram of an imaging control workstation including a standard expansion slot according to an exemplary embodiment of the invention.

While the drawings illustrate system components in a designated physical relation to one another or having electrical communication designation with one another, and process steps in a particular sequence, such drawings illustrate examples of the invention and may vary while remaining within the scope of the invention.

### DETAILED DESCRIPTION

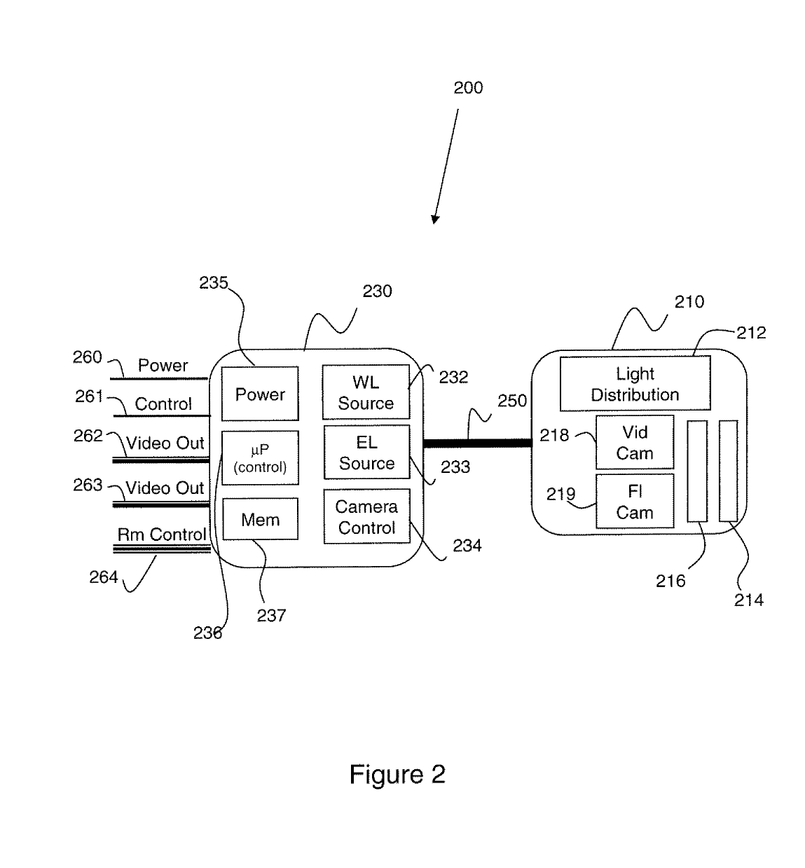

An imaging system, according to one embodiment of the invention, is shown in FIG. 2. The imaging system in the example of FIG. 2 is an optical imaging system that may utilize a fluorescent contrast agent to illuminate various vessels or tissues in the patient. However, as will be described below, other embodiments of the invention utilize different imaging modalities, such as ultrasound probes, endoscopes, and/or laparoscopes, for example. The following detailed description of the optical imaging system in FIG. 2 is merely one example of an embodiment of the invention.

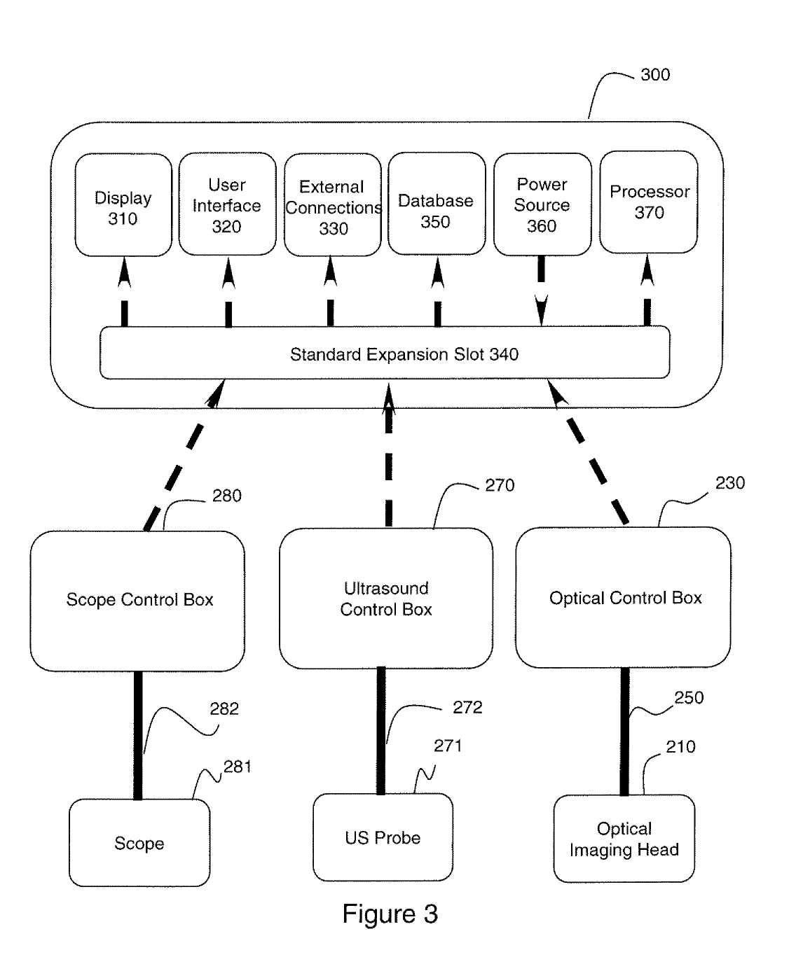

As shown in FIG. 2, the imaging system 200 includes an imaging head 210 and a control box 230 connected by a cable 250. The cable 250 may include components to transmit power, communications, data, and illumination, for example. The cable 250 may also include a component to provide cooling or heat dissipation functions. The imaging system 200 can be used in conjunction with the imaging control workstation 300 shown in FIG. 3. The control box 230 of the imaging system 200 can be inserted into the standard expansion slot 340 of the imaging control workstation 300 of FIG. 3. The imaging control workstation 300 provides a number of functions, such as power conditioning, user interface(s) (such as a mouse, touch screen, monitor, foot pedals, keyboard, voice inputs, etc.), network interface(s) (e.g., DICOM, networking, archiving, printing, etc.), and an interface to the room video distributor, which will be described further below. The imaging control workstation 300 may also provide image processing and data storage functionality that can be utilized by the imaging system 200.

Referring again to FIG. 2, the control box 230 includes a white light source 232 and an excitation light source 233 which transmit light through the cable 250 to a light distribution system 212 in the imaging head 210. The light distribution system 212 in the imaging head 210 transmits the white light and the excitation light to a surgical site in the patient.

The white light source 232 typically comprises a light source adapted to illuminate the patient with a desired range of wavelengths. The white light source 232 may comprise an incandescent, halogen, or fluorescence light source, for example. The excitation light source 233 may be any light source that emits an excitation light capable of causing a fluorescent emission from a fluorescent substance in the patient. The excitation light source 233 may include, for example, light sources that use light emitting diodes, laser diodes, lamps, and the like. The white light source 232 and the excitation light source 233 may each comprise a multitude of light sources and/or a combination of light sources, such as arrays of light emitting diodes (LEDs), lasers, laser diodes, lamps of various kinds, or other known light sources. Either or both of the white light source 232 and the excitation source 233 may include filters (not shown in FIG. 2) to filter out any wavelengths that overlap with the wavelength band of the fluorescent emission from the fluorescent substance (e.g., fluorescent contrast agent) in the patient. The white light and excitation light can be generated by various means. In one implementation, the white light is generated by a filtered broad spectrum light, while the excitation light is generated by a filtered LED or laser diode.

According to other embodiments of the invention, the imaging system 200 includes multiple fluorescent channels (e.g., more than one excitation source and more than one fluorescent emission), and the white light channel may be present or absent. The white light channel may also be referred to as the “color” imaging channel or the RGB channel, for red/green/blue. The white light source may be the ambient room light or the surgical luminary 121, but typically the imaging system 200 includes a white light source 232 to allow custom filtration and control of the white light intensity and spectrum, to optimize the cross-talk to the fluorescent channel or channels. The cross-talk to the fluorescent channel or channels may be caused by an illumination of the fluorescent substance from the white light source 232 (e.g., in the fluorescent emission spectrum) which may be reflected back to the fluorescent detection camera 219 and thus contaminate the fluorescent signal. Moreover, an excitation frequency of the fluorescent substance may be in a narrow band of the optical light frequency and the emission of the fluorescent light may be separated by a narrow bandwidth (e.g., typically approximately 20 nm). Also, the fluorescent signal may be affected by a combination of factors including, for example, excitation spectrum, absorption of the excitation by the fluorescent substance, emission of the fluorescent substance back to the fluorescent camera 219 which detects the fluorescence, and the like. Therefore, cross-talk to the fluorescent channel or channels may be optimized by filtering and controlling the white light intensity and spectrum.

The white light source 232 and the excitation light source 233 transmit light through the cable 250 to the light distribution unit 212 in the imaging head 210. The cable 250 may include, for example, fiber optic cables for transmitting the white light and the excitation light from the control unit 230 to the imaging head 210. The cable 250 typically contains one or more fiber optic cables to carry the light from the control box 230 to the imaging head 210. The cable 250 also typically contains camera wires to connect the cameras 218, 219 to the controls 234. The cable 250 may also include a power connector, although that function may also be supplied by the camera wires. The cable 250 may also include other components, such as to provide cooling functions.

The light distribution system 212 in the imaging head 210 typically includes one or more lenses to redistribute the light received through the cable 250 in a desired manner to the patient. For example, the light distribution system 212 may receive light through a fiber optic cable within the cable 250 and distribute it over a larger cross sectional area. The light distribution system 212 may distribute the received light in order to better illuminate the surgical table 100, minimize a lighting hazard by reducing the intensity of the received light, and/or improve the safety of the imaging system 200. The light distribution system 212 can be designed to produce a distribution of the light that is tailored for the particular operation being performed. For example, in an optical imaging system, the light distribution system 212 may include a first lens that receives white light, for example, and which distributes the white light in a desired intensity to the patient. The light distribution system 212 may include a second lens to distribute an excitation light over a desired area to excite a fluorescent contrast agent in the patient. The second lens may focus the light so that it maintains a relatively high intensity when it reaches the patient. In this way, the light distribution system 212 is effective at transmitting the excitation light with a desired intensity to the patient,

The light distribution system 212 in the imaging head can provide the benefit of reducing or minimizing the thermal loads on the imaging head 210 and the size of the imaging head 210, as compared with a system in which the actual white light source and/or the excitation light source are located in the imaging head 210.

In some cases, however, there may be other advantages to providing the white light source and/or the excitation source in the imaging head 210, such as to avoid transmitting the light through fiber optic cables. According to this embodiment, the imaging head 210 includes a white light source and/or an excitation light source.

Referring again to FIG. 2, the white light transmitted by the light distribution system 212 is reflected at the surgical site in the patient and is received by a first camera 218, which may be a video camera, for example. The video camera is typically used to provide the surgeon with an image of the surgical site during surgery. The excitation light comprises one or more wavelengths selected to excite a particular fluorescent substance in the patient. The fluorescent substance may be a fluorescent contrast agent that is injected into the patient prior to surgery, for example, or it may be an endogenous fluorescent substance. The excitation light excites the fluorescent substance in the patient to cause the substance to emit fluorescent light which is received by the second camera 219. The second camera 219 may comprise a fluorescence camera, for example. The video camera 218 and the fluorescence camera 219 may be referred to as “detectors” and may be digital or analog, for example. The number of cameras may vary from one to many, although two or three cameras is a typical configuration.

Examples of fluorescent contrast agents are known in the art and are described, for example, in U.S. Pat. No. 6,436,682 entitled “Luciferases, fluorescent proteins, nucleic acids encoding the luciferases and fluorescent proteins and the use thereof in diagnostics, high throughput screening and novelty items”; P. Varghese, A. T. Abdel-Rahman, S. Akberali, A. Mostafa, J. M. Gattuso, and R. Carpenter, “Methylene Blue Dye—A Safe and Effective Alternative for Sentinel Lymph Node Localization,” Breast J. January-February 2008;141:61-7, PMID: 18186867 PubMed—indexed for MEDLINE; F. Aydogan, V. Celik, C. Uras, Z. Salihoglu, and U. Topuz, “A Comparison of the Adverse Reactions Associated with Isosulfan Blue Versus Methylene Blue Dye in Sentinel Lymph Node Biopsy for Breast Cancer, Am. J. Surg. February 2008;1952:277-8, PMID: 18194680 PubMed—indexed for MEDLINE; and as commercially available products such as Isosulfan Blue or Methylene Blue for tissue and organ staining.

The imaging head 210 also includes a lens 214 and a beam splitter 216, according to an exemplary embodiment of the invention. The fluorescence emission from the fluorescent substance in the patient and the visible light reflected from the patient are received through the lens 214 and then propagate to the beam splitter 216. The lens 214 is configured to focus an image onto the video camera 218 and the fluorescence camera 219. The lens 214 may be any lens suitable for receiving light from the surgical field and focusing the light for image capture by the video camera 218 and the fluorescence camera 219. The lens 214 may be designed for manual or automatic control of zoom and focus. The beam splitter 216 splits the image information into different paths either spectrally, for example with the use of dichroic filters, or by splitting the image with a partially reflective surface. The beam splitter 216 divides the fluorescence emission from the remainder of the light. The fluorescence emission typically travels through a filter (not shown) and then to the fluorescence camera 219. The filter is configured to reject the reflected visible and excitation light from being detected by the fluorescence camera 219 while allowing the emitted fluorescent light from the patient to be detected by the fluorescence camera 219. The fluorescence camera 219 may be any device configured to acquire fluorescence image data, such as a charge coupled device (CCD) camera, a photo detector, a complementary metal-oxide semiconductor (CMOS) camera, and the like. The fluorescence camera 219 may be analog or digital. The fluorescence camera 219 receives the filtered fluorescence emission and converts it to a signal that is transmitted to an image processing engine, as will be described further below. Typically both the excitation and detection components of the fluorescent channel have optical spectral filters to optimize the signal to noise ratio.

The remainder of the light passes through a second filter (not shown) and then to the video camera 218. The second filter preferably ensures that the excitation light and fluorescence emission is rejected from detection to allow for accurate representation of the visible reflected light image. The video camera 218 may be any device configured to acquire reflectance image data, such as a charge coupled device (CCD) camera, a photo detector, a complementary metal-oxide semiconductor (CMOS) camera, and the like. The video camera 218, which may be analog or digital, receives the filtered reflected light and converts it to a signal or image data that is transmitted to an image processing engine, as will be described further below.

During surgery, the surgeon positions the imaging head 210 to illuminate the patient via a white light generated by the white light source 232 and an excitation light generated by the excitation light source 233 transferred through the cable 250 over a desired area to excite a fluorescent contrast agent in the patient, and to acquire reflectance images and fluorescent images of the patient. The video camera 218 and the fluorescence camera 219 can be used to acquire data used to generate a merged image in which a fluorescence image is superimposed on a reflectance image (i.e., an image comprised of light reflected from the surgical site in the patient). The merged image may assist the surgeon in visualizing the area to be treated and in discriminating certain tissues and vessels during surgery. Examples of methods for creating such a merged image are disclosed, for example, in U.S. Application No. 61/039,038, filed Mar. 24, 2008, entitled “Image Processing Systems and Methods for Surgical Applications,” and U.S. application Ser. No. 12/054,214, filed Mar. 24, 2008, entitled “Systems and Methods for Optical Imaging,” both of which are hereby incorporated by reference in their entireties.

Referring again to FIG. 2, the control box 230 also includes a camera control unit 234, a power unit 235, a system controller 236, and a memory 237. The camera control unit 234, according to an exemplary embodiment of the invention, provides the functions of reading the camera memory, buffering the data, and transferring the data to a computer or display in a defined format, e.g., a computer and display in the imaging control workstation 300 of FIG. 3. Alternatively, these functions may be packaged inside the camera or cameras 218, 219 or in a separate component.

The power unit 235 provides power conditioning and distribution. For example, the power unit 235 may receive as input a conventional alternating current (AC) 120 volt, 60 Hz power supply 260 and may output any desired voltage and current for the control unit 230, the imaging head 210, and the various individual components of these units 230, 210. The cable 250 may include the appropriate wires and/or power transmission channels to transmit the desired power from the power unit 235 to the various components of the imaging head 210.

The system controller 236 controls the operation of the imaging system 200, including the control unit 230 and the imaging head 210. For example, the system controller 236 may control the timing of the imaging system operation, the types of data acquisition, and the data flow. The system controller 236 receives video signals from the video camera 218 and the fluorescent camera 219 of the imaging head 210 through the cable 250 and processes the signals. The system controller 236 may include an image processing engine (e.g., a software module that runs on the system controller 236 and/or additional hardware) that executes various image processing routines on the data acquired with the cameras 218, 219, such as those routines disclosed in the aforementioned U.S. Application No. 61/039,038 and Ser. No. 12/054,214. The image processing engine may utilize the memory 237 for storing, among other things, image data and various computer programs for image processing. The memory 237 may be provided in various forms, such as RAM, ROM, hard drive, flash drive, etc. The memory 237 may comprise different components for different functions, such as a first component for storing computer programs, a second component for storing image data, etc. The image processing engine may include hardware, software or a combination of hardware and software. The image processing engine is programmed to execute various image processing methods. The methods typically involve acquiring frames of image data at different points in time. According to one embodiment, the frames of image data include reflectance data and fluorescence data. The reflectance data sets and the fluorescence data sets may be used to generate a merged image in which the fluorescence image data are overlaid onto the reflectance image data. The merged image assists the surgeon in visualizing certain tissues which emit fluorescent light during surgery.

The control box 230 of the imaging system 200 may include one or more interfaces 260-264, as shown in FIG. 2, for interfacing with the imaging control workstation 300 of FIG. 3 or another shared resource, such as a standalone modality. The interfaces 260-264 on the control box 230 may be packaged as a single, standard interface, which may connect to a complementary standard interface in the standard expansion slot 340 of the control workstation 300. The interfaces on the control box 230 may include, for example, a power interface 260, a control interface 261, one or more video output channels 262, 263, and/or a room control interface 264.

The power interface 260 may comprise an electrical connector that receives a power supply from the power source 360 in the control workstation 300. The received power may be, for example, an alternating current (AC) 120 volt, 60 Hz power supply, or other conventional power supply.

The control interface 261 may link one or more components in the control box 230, directly or indirectly, with one or more components in the control workstation 300. For example, the control interface 261 may link the processor 236 and/or the memory 237 in the control box 230 with the processor 370 and/or the database 350 in the control workstation 300. The processor 370 in the control workstation 300 may also facilitate communications between the control box 230 and other components of the control workstation 300, such as the display 310, user interfaces 320 and external connections 330. The control box 230 can thus gain the benefit of the processing functionality, outputting functionality and/or archiving functionality provided by the control workstation 300. The control interface 261, for example, allows the control box 230 to utilize more advanced user interfaces provided by a dedicated or shared processor or user interface function, such as voice control, in the control workstation 300.

The video output ports 262, 263 on the control box 230 can be configured to interface with the display 310 in the control workstation 300, as shown in FIG. 3. The video output ports 262, 263 can also be configured to interface with a dedicated user interface monitor or a room video distribution function provided in an operating room.

FIG. 2 also depicts a room control interface 264. The room control interface 264 enables synchronization of functions between the imaging system 200 and a room controller. For example, the use or operation of the imaging system 200 can automatically dim the room lights to optimize the image acquisition configuration. Or, the imaging system 200 may be activated through existing controls, such as a footswitch or the imaging control workstation 300 shown in FIG. 3.

The cable 250 shown in FIG. 2 is only one example of a connector between the imaging head 210 and the control box 230. According to another embodiment of the invention, the control box 230 is connected to the imaging head 210 with a wireless connection for data transmission. In this embodiment, power may be supplied to the imaging head 210 either through a wireless power connection or with a battery and charger, for example. Other types of connectors can be used to transmit power, communications, data, and illumination, for example, between the control box 230 and the imaging head 210, as will be appreciated by those skilled in the art.

FIG. 3 illustrates the imaging control workstation 300 that can be used in connection with the optical imaging system of FIG. 2, and/or with other modalities such as ultrasound or endoscope, according to exemplary embodiments of the invention. As explained above, the operating room is often cluttered, and physical space and the general workflow may be very important. There are usually many devices already in the operating room, such as anesthesia machines, ablation machines, cauterization machines, intraoperative ultrasound imaging machines, XRay imaging machines, etc. Currently, imaging devices such as scopes (which can be endoscopes, laparoscopes, etc.) may come with their own standalone control shoeboxes with minimal user interfaces and limited ability to store, process, network, and archive their images. Other imaging machines, such as intraoperative ultrasound or XR imaging machines come with dedicated control workstations which occupy space. FIG. 3 shows a standard imaging control workstation 300 with a standard expansion slot 340 for different imaging modalities. The standard expansion slot 340 can interface with different modalities, such as optical, ultrasound and endoscope, each of which may be designed to have a complementary standard interface. In this way, the control workstation 300 can be shared by a number of different modalities, such as the optical system (210, 230, 250), the ultrasound system (270, 271, 272) and the endoscope system (280, 281, 282) shown in FIG. 3. Those skilled in the art will appreciate that other modalities can be configured to take advantage of the functionality provided by the control workstation 300 by configuring such modalities with a standard interface that connects to the standard interface in the standard expansion slot 340 of the control workstation 300. In this way, different modalities can each gain the benefit of shared functionality such as power conditioning and distribution, user interface(s) (e.g., mouse, touch screen, monitor, keyboard, foot pedals, voice inputs, etc.), network, communication, and/storage interface(s) (e.g., DICOM, networking, archiving and other data storage, printing, etc.), interfaces to the room video distribution system, and functions such as computing, image processing, and display functions. The control workstation 300 is preferably designed to provide services and functionality for the various modalities using both hardware and software.

The functionality provided by the control workstation 300 may include the ability to supply conditioned power, at several voltages or configurable voltages, to the control boxes (230, 270, 280) and imaging heads (210, 271, 281).

The functionality provided by the control workstation 300 may also include the ability to physically hold the control boxes 230, 270, 280 using a standard physical slot and standard connections. This design allows physical transport and storage of the control boxes 230, 270, 280 and imaging heads 210, 271, 281 together with the imaging workstation functions. The ability to physically dock the imaging modality with the imaging workstation 300 allows the integrated system to move easily from room to room.

The functionality provided by the control workstation 300 may also include the ability to physically connect the data transfer and control interfaces easily between the control workstation 300 and the control boxes 230, 270, 280. The control workstation 300 may include standard physical interfaces, such as standard cables and connectors, and/or a specific standard for connector layout, resulting in a standard interface design. The standard interface design may comprise, for example, a universal slot docking slot with standard physical dimensions.

The functionality provided by the control workstation 300 may also include standard data and control interfaces. The control workstation 300 may provide data interfaces, such as the ability to capture images from the control box or boxes and to interface to the room or to an image network. The control workstation 300 may supply such functions as image archives networking, graphical user interface, and advanced image processing. The data and control interfaces may be implemented using standard software interfaces such as HL7 or DICOM to allow data interchange. The control workstation 300 may be configured to display the images on its display 310 or on one or more displays or monitors 122, 131, 140 in the operating room, for example.

The control workstation 300 may also provide image processing functions such as prior image list/select, movie view or review, image fusion, and image annotation. These functions may be supplied once in the control workstation 300 and then used by multiple modalities.

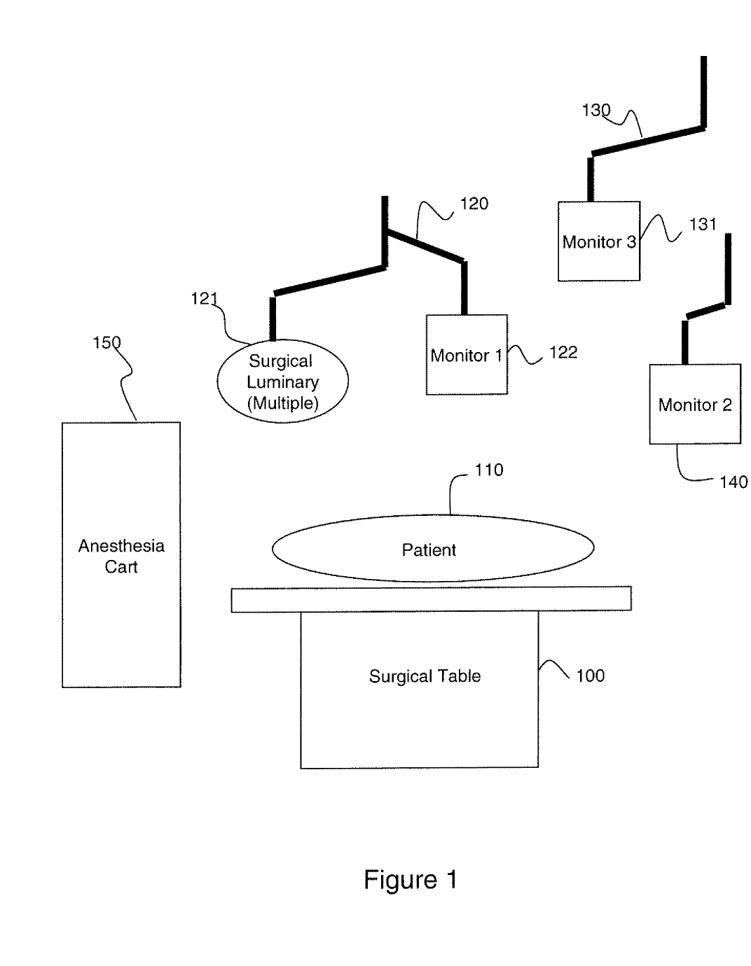

FIG. 3 shows components of the control workstation 300 according to an exemplary embodiment of the invention. The control workstation 300 includes a display 310, a user interface 320, external connections 330, one or more standard expansion slots 340, a database 350, a power source 360, and a processor 370, among other things, to carry out the various functions described above. The display 310 may comprise one or more cathode ray tubes (CRTs), one or more liquid crystal displays (LCDs), one or more plasma displays, and/or other display devices. The user interface 320 may include a mouse, touch screen, keyboard, foot pedals and/or voice inputs, for example. The user interface 320 may allow a user to easily display various images on the display 310 or on operating room monitors. The user interface 320 may include one or more diacritic keys for users having different languages. The external connections 330 may include one or more display connections (e.g., audio and visual connections), one or more local area network (LAN) connections (e.g., ARCNET or Ethernet), one or more wide area network (WAN) connections (e.g., Internet), and/or one or more room interface connections (e.g., Input/Output). For example, the external connections 330 may be used to connect the control workstation 300 shown in FIG. 3 and the optical imaging system 200 shown in FIG. 2 (as well as the ultrasound and endoscope systems shown in FIG. 3) to the monitors 122, 130, 140 and surgical luminary 121 in FIG. 1. The control workstation 300 may include one or more processors 370 to process captured image data.

The standard expansion slot 340 may receive one or more imaging devices. For example, the standard expansion slot 340 may receive the optical control box 230, the intraoperative ultrasound control box 270, the endoscope control box 280, and/or other imaging devices. More than one expansion slot 340 may be included in the control workstation 300.

In an exemplary embodiment, the work station 300 may include a database 350 to archive images generated by various imaging procedures. Also, the database 350 may copy the images generated by various imaging procedures. The database may comprise memory such as a hard disk drive, flash drive, RAM, ROM, etc. and associated database software, for example.

The working station 300 may also include a power source 360 coupled to an external power source (e.g., AC power source, or DC power source). The power source 360 may be a variable power source configured to supply different power levels for different modalities. Also, the power source 360 may be configured to supply different power levels as selected by a user using the user interface 320.

According to exemplary embodiments of the invention shown in FIG. 3, various imaging modalities are configured as standalone control boxes plus imaging heads. Thus, the optical imaging modality includes the control box 230, cable 250, and imaging head 210; the ultrasound modality includes the ultrasound control box 270, cable 272, and ultrasound probe 271; and the endoscope modality includes the endoscope control box 280, cable 282, and endoscope 281. The term “imaging head” may be used generally to refer to the optical imaging head 210, the ultrasound probe 271 or the scope 281.

The ultrasound control box 270 may include features to assist a surgeon in visualizing the anatomy of the patient in real time using ultrasonic waves. The ultrasound probe 271 may include transducers that generate ultrasonic waves and receive ultrasonic waves reflected from the patient. The ultrasonic control box 270 processes the received waves to generate ultrasonic images. The ultrasound control box 270 may produce tomographic ultrasound images (TUT) that display multiple parallel slices within a volume data set. The ultrasound control box 270 may generate high-definition, multi-dimensional images that may be viewed in different planes, as will be appreciated by those skilled in the art. When the ultrasound control box 270 is connected to the control workstation 300, the integrated system provides the various enhanced functionality described above for the ultrasonic imaging modality, such as user interfaces, displays, external connections, storage and archiving, image processing capabilities, etc.

The endoscope imaging system 280, 281, 282 may include features to assist a surgeon in visualizing the anatomy of a patient in real time using an endoscope. The endoscope may be used in endoscopic surgery, which can be significantly less invasive as compared with open surgery. The endoscope is inserted into a small incision in the patient, as known in the art, to minimize the invasive nature of the surgery. The endoscope control box 280 or the endoscope 281 may include a light source for illuminating organs, tissues, and/or vessels of the patient. The endoscope 281 may include proximal detectors or distal detectors. Proximal detectors are located near the top end of the endoscope proximate to the surgeon. Distal detectors are located at the bottom end of the endoscope away from the surgeon. The detectors receive light reflected from a surgical site in the patient, and generate image signals which are processed to produce real time images of the patient, as is known in the art. When the endoscope control box 280 is connected to the control workstation 300, the integrated system provides the various enhanced functionality described above for the endoscopic imaging modality, such as user interfaces, displays, external connections, storage and archiving, image processing capabilities, etc. The endoscopic imaging system described herein can also be modified to include a laparoscope. A laparoscope is typically inserted into an incision in the abdomen to provide access to an interior of the abdomen in a minimally invasive procedure.

The control boxes of the various modalities 230, 270, 280 may be configured in a set of expansion slots 340 either serially (docking and undocking control boxes into the same slot as needed for individual interventions), or in parallel (docking multiple control boxes for the same or different imaging modalities into multiple expansion slots 340). This arrangement allows one control workstation 300 to serve multiple control boxes and imaging heads. The control workstation 300 can thus provide the advantages of reducing the operating room floor space needed by the imaging equipment, and reducing cost of equipment through sharing of storage disks, interfaces, computing resources, power supplies, displays, and/or cabinet hardware, etc. Multiple expansion slots 340 can facilitate the configuration of the control workstation 300.

The image processing engine which processes the image data acquired by the image detectors has been described above as residing in the control box. However, according to other embodiments of the invention, some or all of the image processing functionality can be performed by the imaging control workstation 300. For example, the imaging control workstation 300 may perform image processing functionality such as image manipulation and formatting, image merge, image storage, image analysis, video distribution, image archiving, etc.

According to another embodiment of the invention, the control box (230, 270, 280) is connected to a standalone imaging modality that provides one or more of the following functions. power conditioning, power distribution power supply, user interfaces, network, communication, and/storage interface(s), interfaces to the room video distribution system, computing, image processing, and display functions, e.g., with a separate monitor. The standalone imaging modality may include a standard interface, such as the standard interface described above in the expansion slot 340 of the control workstation 300. The standard interface on the standalone imaging modality may connect to the standard interface on the control box 230, 270, 280, enabling the standalone imaging modality to provide one or more of the aforementioned functions. This arrangement can provide the benefits of minimizing operating room floor space and reducing cost by sharing imaging resources, such as sharing of storage disks, interfaces, power supplies, cabinet hardware, etc.

According to another embodiment of the invention, the imaging control workstation 300 is connected to a standalone imaging modality, such as a surgical c-arm. In this configuration, the imaging modality is not placed into the standard expansion slot 340, since it is too large, but this arrangement can still provide the same benefits of minimizing operating room floor space and reducing cost by sharing imaging resources for the control workstation 300, such as sharing of storage disks, interfaces, power supplies, cabinet hardware, etc. The standalone imaging modality may include a standard interface (such as the standard interface on the control box 230) which connects to a standard interface on the control workstation 300.

Referring again to FIG. 2, according to another embodiment of the invention, the control box 230 and the imaging head 210 can operate independently of any other room connection. According to this embodiment, the system may include limited controls, such as an LCD screen or other display and buttons or knobs allowing the user to interface with the system. The system may include its own power supply, such as a battery. The system may display images on its own display, or it may alternatively be connected to a room monitor 122, 131, 140 for displaying images. The system may store images in the memory 237 that can be later uploaded to a workstation for additional image processing, enhancement and storage.

While the foregoing description includes details and specific examples, it is to be understood that these have been included for purposes of explanation only, and are not to be interpreted as limitations of the present invention. For example, there are various types of image data and sensors that can be used in various embodiments of the present invention. In addition, although the above-described embodiments relate primarily to surgical applications, exemplary embodiments of the present invention can be adapted for non-surgical applications Modifications to the embodiments described herein can be made without departing from the spirit and scope of the invention, which is intended to be encompassed by the following claims and their legal equivalents.

1. A system comprising:
an imaging head comprising an imaging sensor that receives image information from a subject and converts the image information into an image signal;
a control unit that receives the image signal from the imaging head, wherein the control unit comprises:
a processor programmed to control the operation of the system and to generate a plurality of image frames for transmission to a monitor separate from the system;
a video interface designed to transmit the plurality of image frames to the monitor; and
a power interface designed to receive power from a power supply separate from the system; and
a connector that connects the imaging head and the control unit;
wherein the control unit is adapted to interface with at least one of: an imaging control workstation having a standard interface that receives the control unit; and a separate standalone imaging modality providing the separate monitor and the separate power supply.

2. The system of claim 1, wherein the connector between the imaging head and the control unit comprises a cable.

3. The system of claim 1, wherein the control unit comprises a white light source, the imaging head comprises a light distributor, and the connector transmits light from the white light source to the light distributor.

4. The system of claim 1, wherein the imaging sensor comprises at least one camera.

5. The system of claim 1, wherein the control unit comprises a power conditioning unit.

6. The system of claim 1, wherein the imaging sensor comprises a fluorescent camera.

7. The system of claim 1, wherein the imaging head comprises an ultrasound probe.

8. The system of claim 1, wherein the imaging head comprises an endoscope.

9. A method of manufacturing comprising:
providing an imaging head comprising an imaging sensor that is configured to receive image information from a subject and to convert the image information into an image signal;
providing a control unit that is configured to receive the image signal from the imaging head, wherein the control unit comprises:
a processor programmed to control the operation of the system and to generate a plurality of image frames for transmission to a monitor separate from the system;
a video interface designed to transmit the plurality of image frames to the monitor; and
a power interface designed to receive power from a power supply separate from the system; and
connecting the imaging head to the control unit with a connector;
wherein the control unit is adapted to interface with at least one of: an imaging control workstation having a standard interface that receives the control unit; and a separate standalone imaging modality providing the separate monitor and the separate power supply.

10. The system of claim 9, wherein the connector between the imaging head and the control unit comprises a cable.

11. The system of claim 9, wherein the control unit comprises a white light source, the imaging head comprises a light distributor, and the connector transmits light from the white light source to the light distributor.

12. The system of claim 9, wherein the imaging sensor comprises at least one camera.

13. The system of claim 9, wherein the control unit comprises a power conditioning unit.

14. The system of claim 9, wherein the imaging sensor comprises a fluorescent camera.

15. The system of claim 9, wherein the imaging head comprises an ultrasound probe.

16. The system of claim 9, wherein the imaging head comprises an endoscope.
